(19) United States
(12) Patent Application Publication
(10) Pub. No.: US 2025/0272469 A1
(43) Pub. Date: Aug. 28, 2025

(54) CONFIGURING AN H-TREE ASSOCIATED WITH A BOUNDING BOX

(71) Applicant: Microsemi SoC Corp., Chandler, AZ (US)

(72) Inventor: Fei LI, San Jose, CA (US)

(21) Appl. No.: 19/067,811

(22) Filed: Feb. 28, 2025

Related U.S. Application Data
(60) Provisional application No. 63/559,182, filed on Feb. 28, 2024.

(51) Int. Cl. G06F 30/396; G06F 30/3947

(52) U.S. Cl. CPC G06F 30/396; G06F 30/3947

(57) ABSTRACT

In some implementations, a computing device may identify a set of candidate configurations of bounding boxes on a field programmable gate array (FPGA). The computing device may construct H-trees associated with respective candidate configurations. Identifying the H-trees may include identifying a level of an H-tree associated with a candidate configuration and a bounding box of the clock domain placement. Identifying the H-trees may include identifying a tree center of the H-tree that is located outside of the bounding box. Identifying the H-trees may include relocating a tree center or adjusting the bounding box. Relocating the tree center may include reflecting the tree center into the bounding box. Adjusting the bounding box may include shifting the bounding box to include the tree center.

### CROSS-REFERENCE TO RELATED APPLICATION

This Patent Application claims priority to Provisional Patent Application No. 63/559,182, filed on Feb. 28, 2024, and entitled “CONFIGURING AN H-TREE ASSOCIATED WITH A BOUNDING BOX.” The disclosure of the prior Application is considered part of and is incorporated by reference into this Patent Application.

### FIELD

The present disclosure generally relates to generating H-tree configurations for providing clock signaling to clock regions of a device (e.g., a field programmable gate array (FPGA)). The clock signaling provides a reference for different clock regions to synchronize timing for time-based operations. The H-tree may be used to form clock routes to distribute the clock signaling to the clock regions at a same time (e.g., with a same latency) or nearly the same time (e.g., with a difference in latency that is within a threshold). In some aspects described herein, the H-tree may be formed within a placement bounding box having a size that is a quantity of clock regions.

### BACKGROUND

A computing device may include multiple clock regions that are to be synchronized for proper function of the computing device. The computing device may include dies that each include a set of clock regions (e.g., 8×8 clock regions). The computing device may include a field programmable gate array (FPGA) or a storage device (e.g., a non-volatile memory device, such as a negative-and (NAND) flash memory device).

The computing device forms clock routes for providing clock signaling to each of the clock regions of the computing device. Synchronization may be improved by configuring clock routes to have similar lengths from an input of the clock signal.

### SUMMARY

In some implementations, a method performed by a computing device includes identifying a set of candidate configurations of bounding boxes on a field programmable gate array (FPGA). The method includes constructing H-trees associated with respective candidate configurations. Identifying the H-trees includes identifying a level of an H-tree associated with a candidate configuration and a bounding box of the bounding boxes. Identifying the H-trees includes identifying a tree center of the H-tree that is located outside of the bounding box. Identifying the H-trees includes relocating the tree center or adjusting the bounding box, wherein: relocating the tree center comprises reflecting the tree center into the bounding box, or adjusting the bounding box comprises shifting the bounding box to include the tree center.

In some implementations, a system includes a computing device associated with an FPGA. The computing device is to identify a set of candidate configurations of bounding boxes on an FPGA. The computing device is to construct H-trees associated with respective candidate configurations. To identify the H-trees, the computing device is to identify a level of an H-tree associated with a candidate configuration and a bounding box of the bounding boxes. To identify the H-trees, the computing device is to identify a tree center of the H-tree that is located outside of the bounding box. To identify the H-trees, the computing device is to relocate the tree center or adjustment of the bounding box. Relocation of the tree center includes reflecting the tree center into the bounding box or adjustment of the bounding box comprises shifting the bounding box to include the tree center. The computing device is to identify the H-trees, the computing device is to receive a clock information at clock regions of the FPGA via clock routes associated with the H-tree.

In some implementations, a computer program product comprising: one or more computer readable storage media, and program instructions collectively stored on the one or more computer readable storage media, the program instructions comprising: program instructions to identify a set of candidate configurations of bounding boxes on a field programmable gate array (FPGA); and program instructions to construct H-trees associated with respective candidate configurations, identification of the H-trees comprising: identification of a level of an H-tree associated with a candidate configuration and a bounding box of the bounding boxes; identification of a tree center of the H-tree that is located outside of the bounding box; and relocation of a tree center based at least in part on reflecting the tree center into the bounding box.

### BRIEF DESCRIPTION OF THE DRAWINGS

FIGS. 1A-1D are diagrams of an example of identifying an H-tree associated with a bounding box described herein.

FIGS. 2-3 are diagrams of example components of one or more devices used in conjunction with FIG. 1.

FIGS. 4A-4J are diagrams of examples of identifying H-trees associated with bounding boxes described herein

FIGS. 5-7 are flowcharts of example processes associated with using different ordered erase and write operations described herein.

### DETAILED DESCRIPTION

The following detailed description of example implementations refers to the accompanying drawings. The same reference numbers in different drawings may identify the same or similar elements.

A computing device may include multiple clock regions that are to be synchronized for proper function of the computing device. For example, synchronization of clock regions supports time-based or sequential commands among the clock regions. The computing device may include dies that each include a set of clock regions (e.g., 8×8 clock regions). In some examples, a largest monolithic die may be limited to 8×8 clock regions. For clock regions with 15K logical elements (LEs) each, the largest die has 960K LEs. The largest die with a microprocessor sub-system (MSS) cutout has approximately 900K LEs.

The computing device (e.g., a field programmable gate array (FPGA)) may include an FPGA fabric that includes a repeated structure (e.g., a repeated pattern of substructures). For example, a clock mesh may be formed within the FPGA fabric, which includes a grid of conductive structures (e.g., metal wires) and global switch box (GSBs) at intersections of the conductive structures. The GSBs at intersections of the conductive structures may be used to pass signals in a straight line, to change a direction of a signal, or to split a signal for sending on multiple downstream conductive structures. The computing device may use this clock mesh to distribute clock signaling, enable signaling, reset signaling, or control signaling to clock regions of the computing device. Timing of the signaling may be important for proper functioning of the computing device, so a configuration of the distribution of the signaling can affect performance of the computing device.

To improve performance, the computing device may use a data structure to represent components of an FPGA device, such as a multi-level H-tree, to determine how to distribute signals in the FPGA device. In some embodiments, a multi-level H-tree may include a plurality of levels. Each level in the plurality of levels may include a plurality of tree edges. A tree edge in a multi-level H-tree may represent a conductive structure of a clock mesh in the FPGA device. A tree center in a multi-level H-tree may represent a GSB in the FPGA device.

Global network routing may utilize up to three levels of hierarchy for H-trees. In the context of global network routing within FPGA devices, an H-tree refers to a physical routing topology of a clock or other global signal constructed on a programmable global network in FPGA devices. The programmable global network is a programmable hardware piece in the FPGA device that can be programmed to construct a desired routing topology to meet certain timing or skew requirement of a global signal. The specific routing topology (referred to as an H-tree in this disclosure), and a specific way of constructing such a topology within bounding box constraints, allows the programmable global network on an FPGA device to support more clock and reset domains for user designs.

A programmable hardware piece, in this case a programmable global network, is manufactured on the FPGA device once. The programmable hardware piece if made of clock tracks (e.g., metal wires), of certain fixed physical length, located in the routing channels of that fixed length. The clock tracks of certain fixed physical lengths may be referred to as “segments” or “clock routing segments.” The FPGA includes switch boxes in between those segments so that multiple segments can be connected to form longer connections or change directions. This kind of flexibility is a benefit of FPGA devices, but the hardware properties of those clock routing segments (e.g., components) are the same. An FPGA vendor software can program switch boxes differently to form a different topology of clock routing trees. Some switch boxes can be programmed to serve as tree centers. Some are programmed to extend the reach of the clock signals, forming tree edges. After programming, some routing segments are at a lower level of the H-tree topology, and some are at the higher level of the H-tree topology. The unique programmability feature of the FPGA device makes the same and often repeatable hardware components serve different purposes after being programmed.

In some examples, a level of an H-tree may include full or partial H elements. Using H-trees may help to match clock route lengths and balance clock delay to sinks. A sink refers to a target pin that a signal is intended to reach. A global signal such as a clock is to reach thousands, tens of thousands, or hundreds of thousands of clock pins depending on a size of the FPGA device (e.g., according to user designs), which may be challenging to design routing in the FPGA device. Using H-trees constructed within the placement bounding box may help reduce clock resource usage, limit clock latency, and reduce power consumed. The computing device may be configured to construct hierarchical H-trees within an associated bounding box in units of clock regions. In this way, the configuration of the H-trees may automatically deal with scenarios where balanced H-trees are constructed out of a fabric array.

In an ideal case, E(n+1)=2*E(n), where E(n) is a tree edge length at hierarchy level “n.” In other words, a tree edge length for a particular level of the H-tree is ideally twice as long as a tree edge length for a next-lowest level of the H-tree. A level of the H-tree may be formed using simple construction by forming an “H” using tree centers of the next-lowest level of the H-tree.

In some aspects described herein, a computing device may attempt to construct an H-tree within a bounding box that does not support a simple construction of a layer of the H-tree within the bounding box. The H-tree may be a delay-balanced H-tree. In some aspects, the computing device may relocate one or more tree centers of the layer of the H-tree or may adjust the bounding box (e.g., shift the bounding box). In this way, the H-tree may be contained within the bounding box. Based on keeping the tree center within the bounding box, the H-tree of the bounding box may include clock routes that traverse edges of clock regions within the bounding box and may avoid interference with clock signals of other bounding boxes.

Relocating the tree center may include folding the tree center back into the bounding box. For example, the tree center may be preliminarily located at a position that is outside of the bounding box by one clock region from any edge of the boundary box. The tree center may be folded (e.g., reflected or mirrored) back into the bounding box such that it is located one clock region from the edge, but within the boundary box.

In an example set of operations for constructing layers of the H-tree, the computing device may begin with tree centers from a previous level n=0 and construct new H-trees at n=1. Whenever a tree center is outside of an associated bounding box, the computing device may mirror the tree center back into the bounding box. A mirrored tree-center may be constrained to move a distance of “2*E(1)” along one dimension from its original position (e.g., a preliminary position). Vertical routing tracks at n=1 may be expected to be on a different grid than that at n=0. Horizontal routing tracks at n=1 may be expected to be on a different grid than that at n=0.

However, folding the H-tree at n=1 may cause trouble in routing at n=2. For example, horizontal routing tracks at n=2 are not expected to be on a different grid than that at n=0 or n=1. Other topology may be attempted, but the H-tree at n=2 may be forced to overlap with a routing track (e.g., an edge between clock regions) of a lower level of the H-tree. In this case, the computing device may use two different clock planes per clock domain (e.g., associated with a bounding box).

As described herein, vertical folding may cause horizontal routing overlap between levels. Horizontal folding does not cause vertical routing overlap between levels. Folding may not happen at leaf level (n=0) because minimum size H-trees are at the leaf level. Vertical folding can occur at the middle level (e.g., n=1). Vertical folding does not cause a routing problem at n=1 alone but may cause horizontal routing overlaps at level n=2.

Vertical folding may occur at a top level (n=2). There are at most four previous tree centers in a 2×2 array at n=2. If 1 previous tree center exists at n=2, the top level hierarchy may not be used at all. If 3 or 4 previous tree centers exist at n=2, no folding can happen at n=2. But a sole horizontal routing track at n=2 may overlap with routing tracks at lower levels, causing two clock planes being used for one clock domain if vertical folding occurred at previous level. If 2 previous tree centers exist at n=2, vertical folding may happen at n=2. This increases a number of clock planes when vertical folding also occurred at n=1.

In some aspects, folding may cause an H-tree to use multiple clock planes per clock domain when routing tracks overlap from different levels of the H-tree. Two conditions that may cause route overlap between a top level (e.g., n=2) and any of the two lower levels (n=0 or n=1) include H-tree vertical folding at a middle hierarchy level (n=1) and horizontal routing at the top hierarchy level (n=2). However, at most one horizontal routing track at the top level (n=2) may have an overlap, so up to two planes are utilized within a bounding box.

If a bounding box is enclosed by a 2×2 clock region array, one level of a single H-tree is utilized. Folding does not happen at the leaf level and one clock plane per clock domain is sufficient.

If a bounding box is enclosed by a 4×4 clock region array but not by a 2×2 clock region array, one previous tree center may exist at the top level (n=2), no horizontal routing may be utilized at the top level, and one clock plane per clock domain is sufficient.

If a bounding box is enclosed by an 8×8 clock region array but not by a 4×4 clock region array, folding can happen at middle level (n=1) when either of the bounding boxes width or height is 1 or 5 clock regions. Considering the conditions for routing overlap, a placer may detect usage of two clock planes per clock domain based on if ((H==1∥H==5) && W>=5) { . . . }.In these cases, there are 8 possible bounding boxes to consider with four orientations per bounding box.

In some aspects, the computing device may avoid route overlaps for a clock domain by making sure that a microprocessor subsystem (MSS) cutout does not go beyond a size of 2×2 and increasing the bounding box from having 3 rows to having 4 rows.

In some aspects, the computing device may use a shift operation to adjust the bounding box to align partial sub H-trees at a boundary of the bounding box. In some aspects, the shifting operation may be used when a fold operation would otherwise cause a routing track to overlap with another layer of the H-tree.

In some aspects, a placer may store an entire seam usage for all one-clock-plane feasible bounding boxes. The seam usage may be based on one fixed bounding box orientation. Different orientations may not be useful in reducing routing overlap between clock domains, such as when all bounding boxes can be made to be one-clock-plane feasible. In this way, software may not consume resources to deal with different orientations.

In some aspects, the placer may check a seam capacity constraint in a “spreading phase” of the placer (e.g., an analytic placer). In an example, an initial seam capacity allocation may include 24 for distribution tracks and 32 for both distribution and transmission tracks.

In some aspects, the global router may use a maze router to route transmission tracks from a clock source to the root of a hierarchical H-tree in a shortest distance.

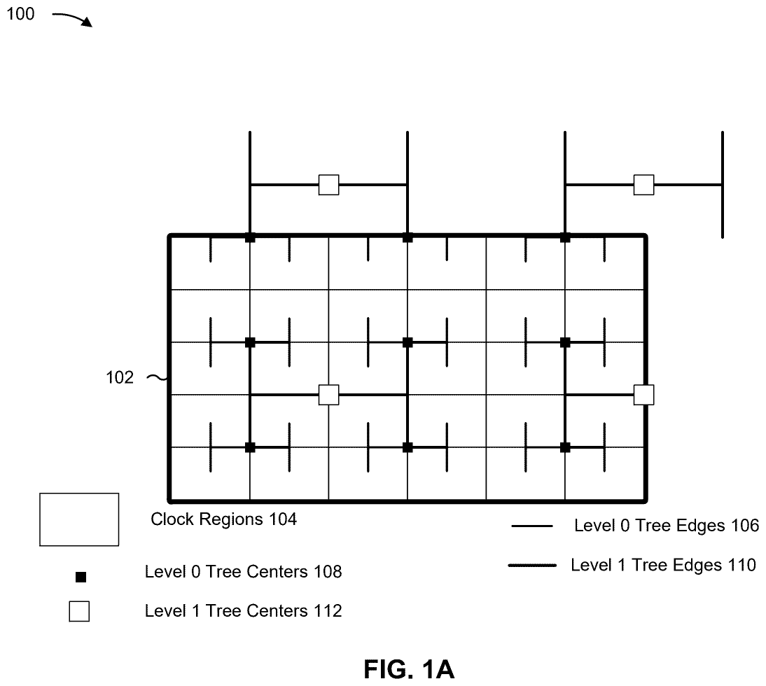

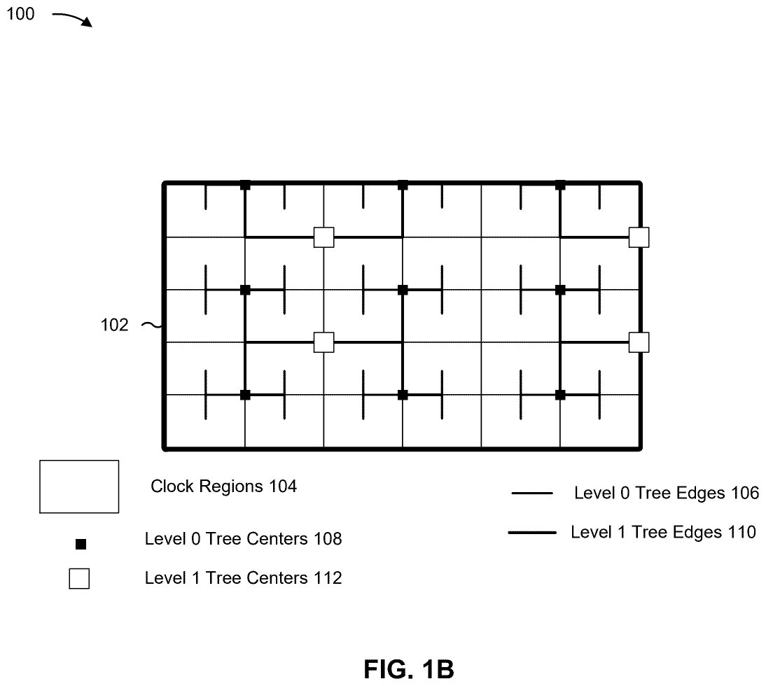

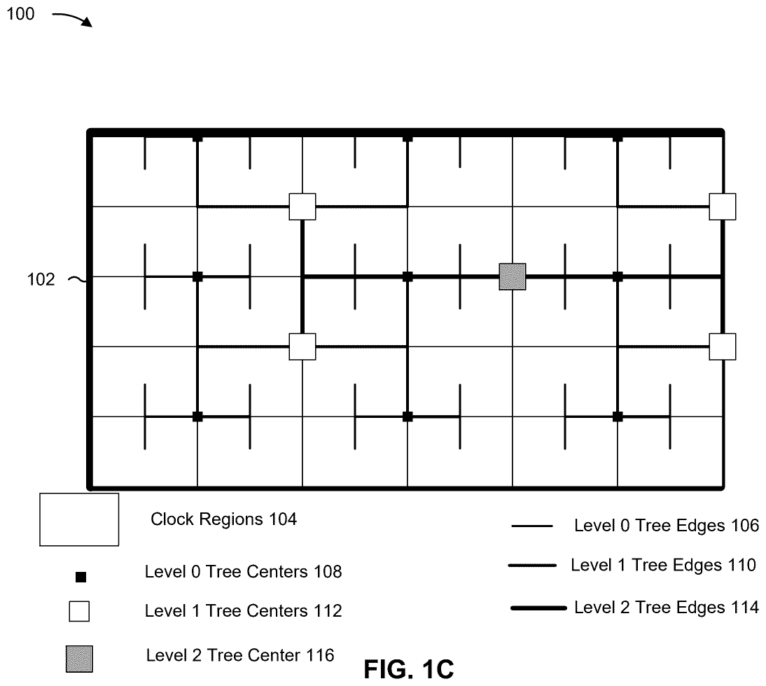

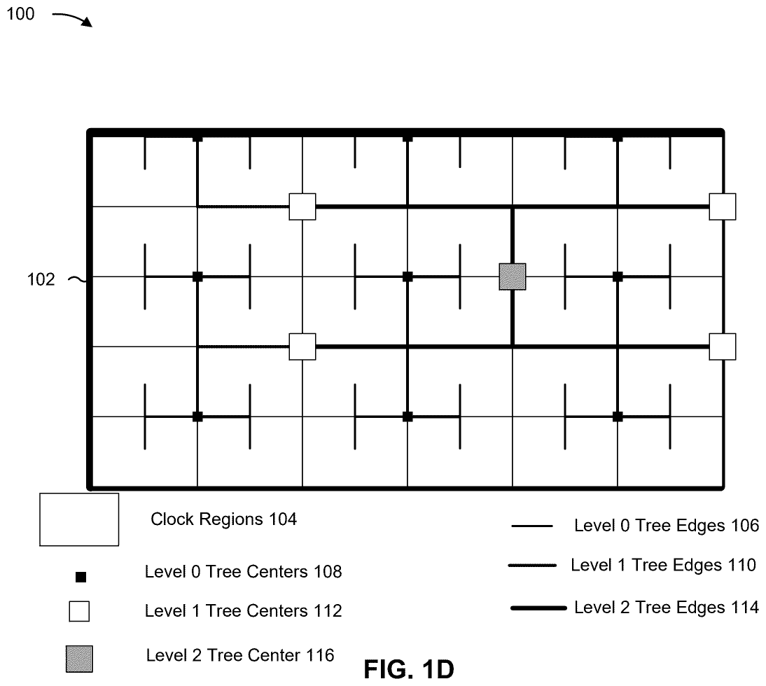

FIGS. 1A-1F are diagrams of an example 100 of identifying an H-tree associated with a bounding box described herein. In context of FIGS. 1A-1F, a computing device may use a multi-level H-tree data structure to represent components of an FPGA device to determine how to distribute control signals, such as enable signaling, reset signaling, or clock signals, among other examples. Tree edges of multi-level H-trees may represent conductive structures of a computing device (e.g., FPGA) and tree centers may include GSBs of the computing device. The computing device (e.g., FPGA) may program the FPGA using the H-trees to construct the pathways (comprising structures of the FPGA) for delivery of signaling to clock regions of the computing device. For example, the tree centers may operate as nodes through with the computing device sends signaling (e.g., clock signals) to clock regions of the computing device and the tree edges may be used as conductive material to carry the signal between nodes.

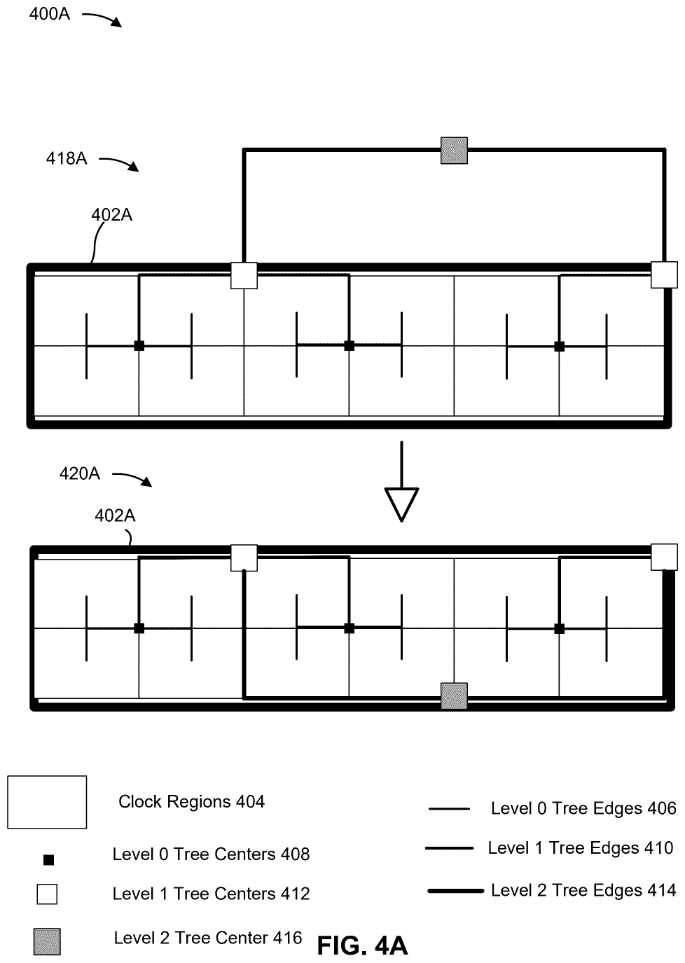

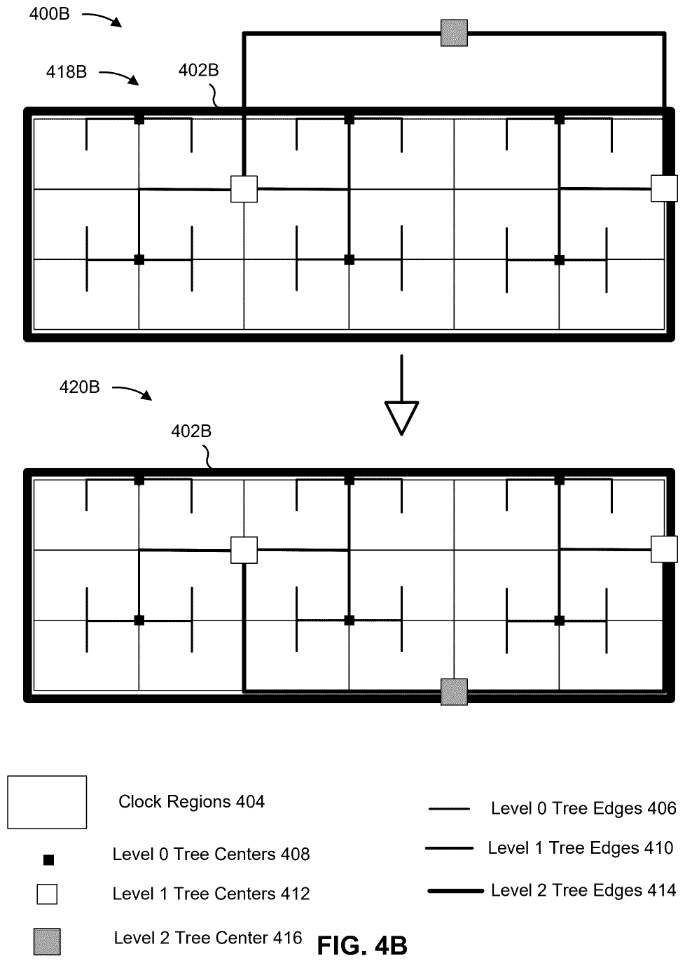

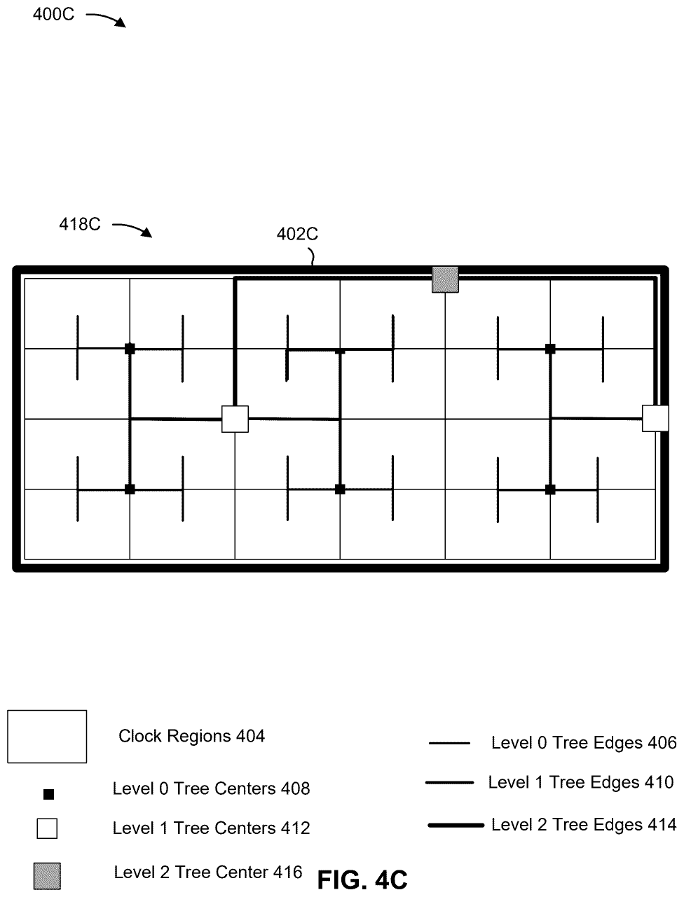

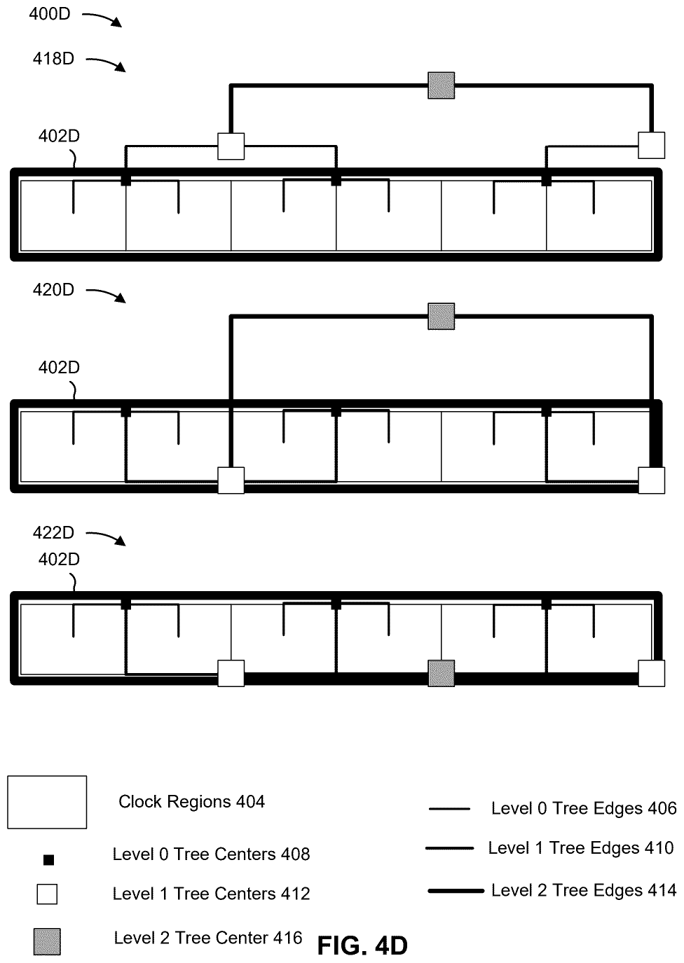

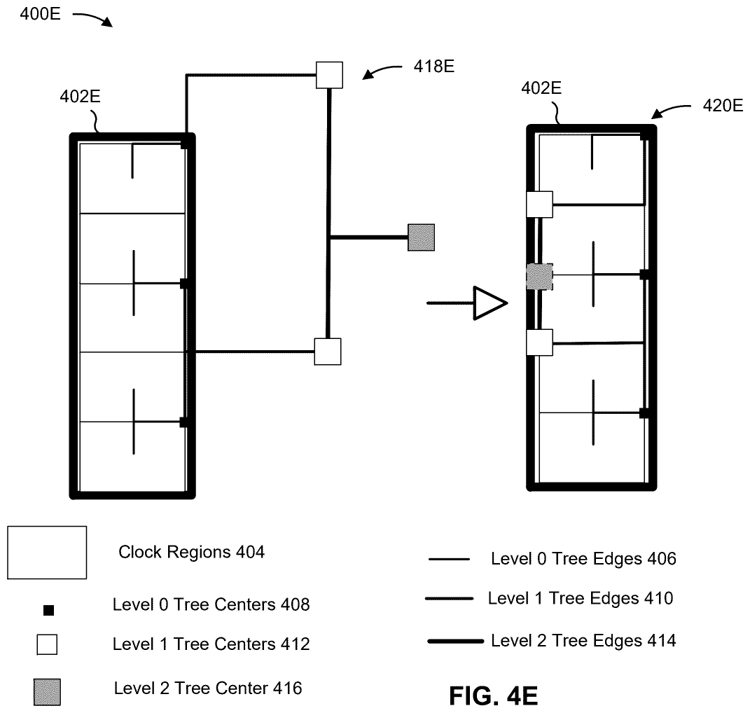

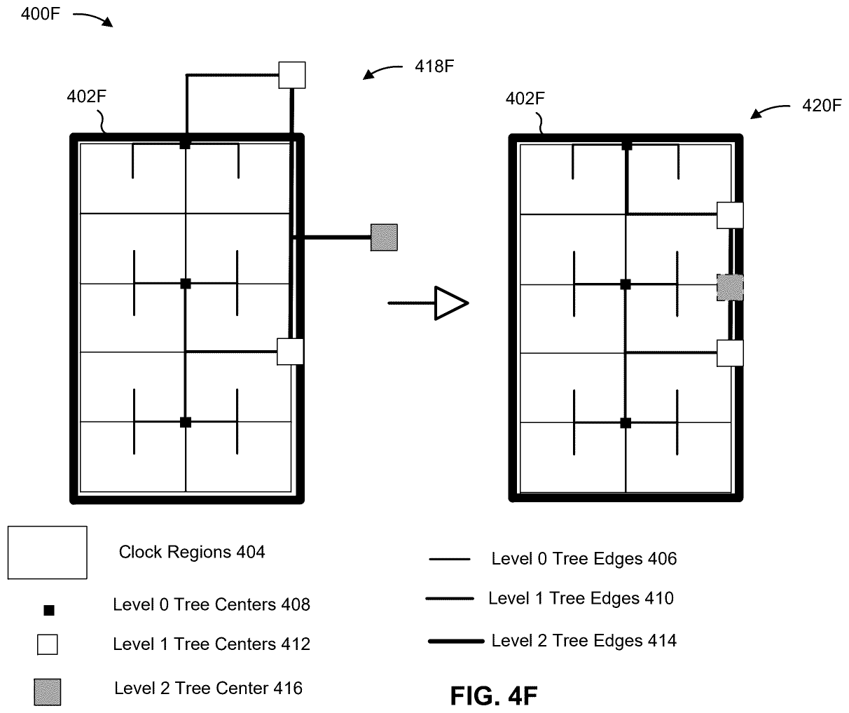

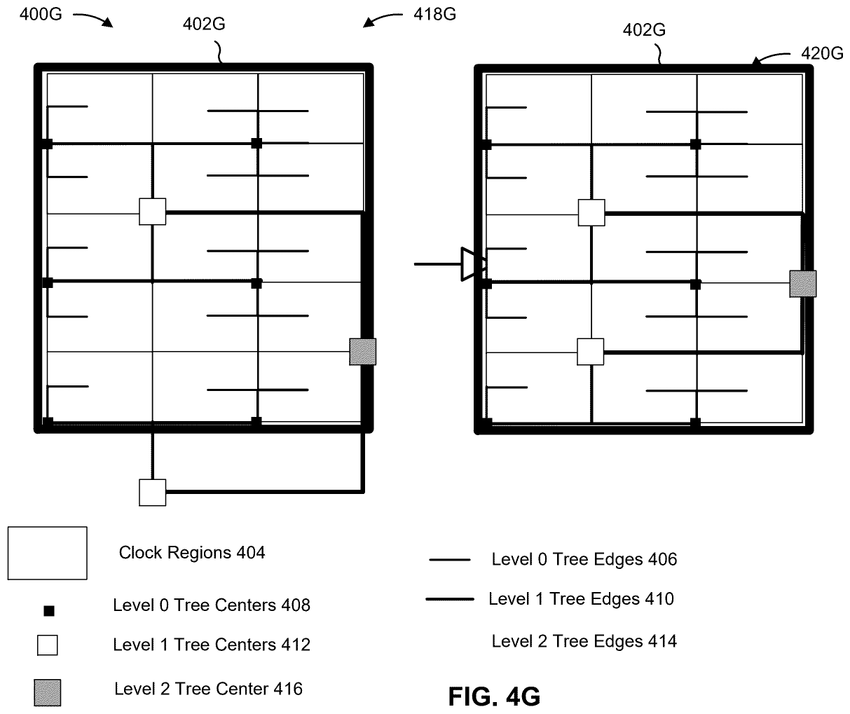

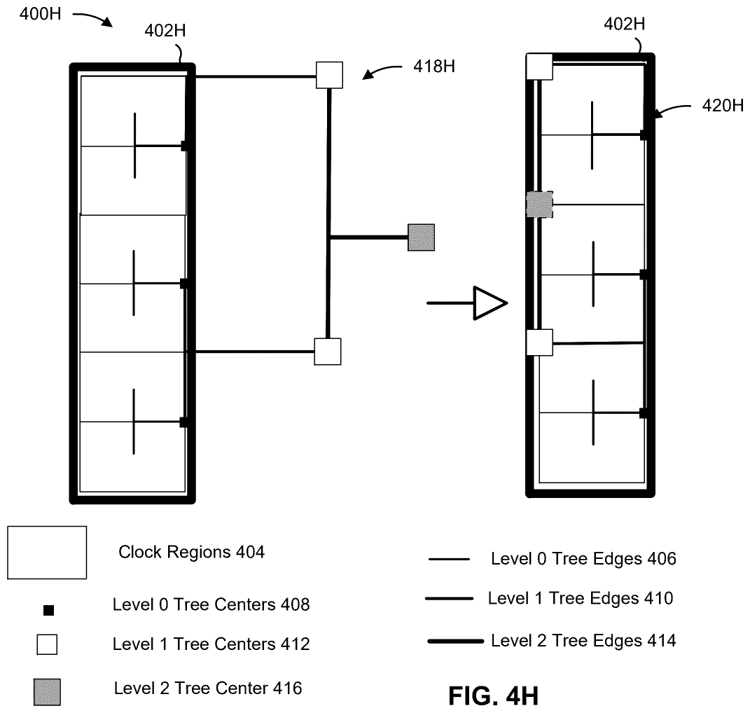

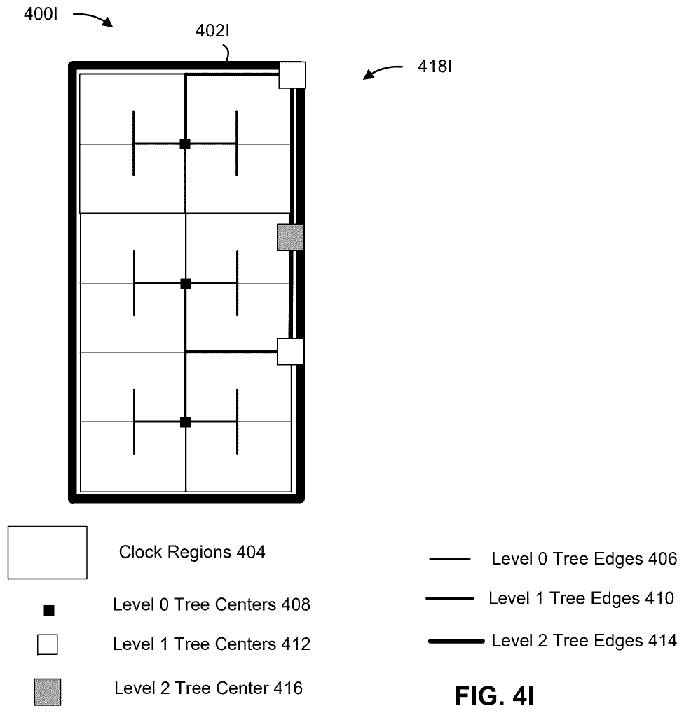

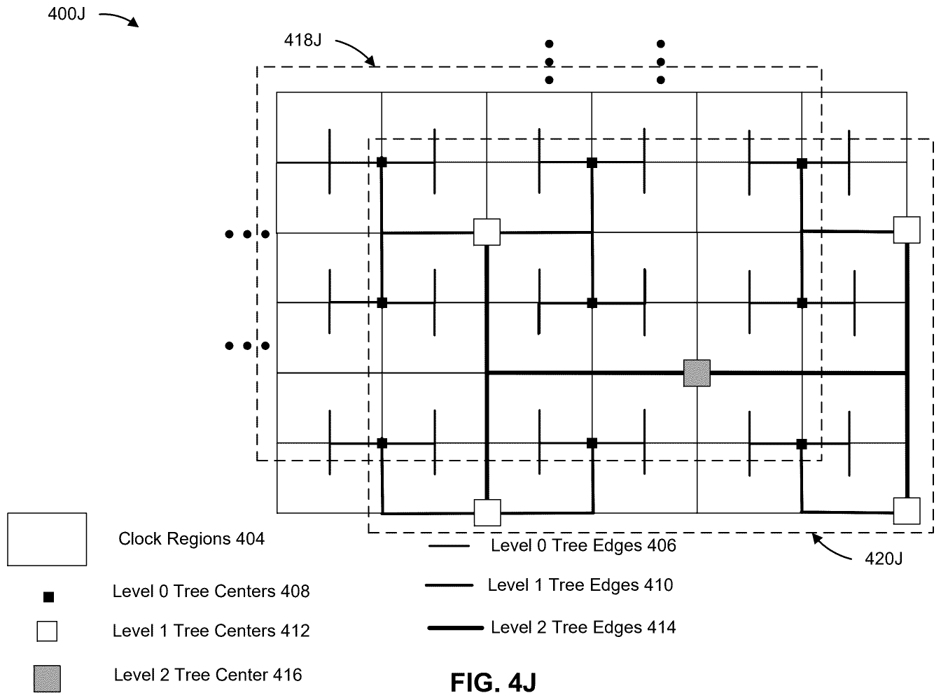

Once an H-tree is configured, as shown in FIGS. 1A-1F (or in FIGS. 4A-4J), the computing device may use the H-tree as a distribution path for signals such as clock signals. For example, a computing device may use an oscillator (e.g., an external oscillator) to generate an external clock signal (e.g., at 100 megahertz (MHz)). The computing device may use a phase-locked loop (PLL) to generate a system clock signal using the external clock signal (e.g., at 200 MHz). The computing device may provide the system clock signal to a root GSB (e.g., a highest level of the H-tree) to begin the distribution process through the H-tree. The root GSB provides the system clock signal to one or more tree centers of a next level of the H-tree via tree edges (e.g., via conductive structures of the FPGA), which continue to provide the system clock signal to subsequent tree centers of the H-tree until the system clock signal reaches clock regions of the FPGA. The distribution of the system clock signal supports synchronized operations of the FPGA and reduces operational errors that may otherwise be caused by operations on different portions of the FPGA being performed out of order (e.g., based at least in part on being out of synchronization).

As shown in FIG. 1A, a computing device (e.g., an FPGA) may include a bounding box 102 that includes clock regions 104. The bounding box can come in different shapes, depending on the placement of user design blocks, and may occupy a part of the computing device. A layer 0 of an H-tree for distributing clock information may include level 0 tree edges 106 connecting the clock regions 104 to Level 0 tree centers 108. Layer 0 may be formed with the level 0 tree edges 106 in a shape of a full or partial “H” shape with the level 0 tree centers 108 in a center of the “H” shape formed by the level 0 tree edges 106 (or where the center would be if the “H” was a full “H”).

A layer 1 of the H-tree may include level 1 tree edges 110 connecting the level 1 tree centers 108 to level 1 tree centers 112. Layer 1 may be formed with the level 1 tree edges 110 in a shape of a full or partial “H” shape with the level 1 tree centers 112 in a center of the “H” shape formed by the level 1 tree edges 110 (or where the center would be if the “H” was a full “H”).

When forming the layer 1 of the H-tree, the computing device may configure H-shaped (full or partial) level 1 tree edges 110 that connect each of the level 0 tree centers 108 to a layer 1 tree center 112. If possible, each layer 0 tree center 108 may be equally distant from an associated layer 1 tree center 112 along the layer 1 tree edges 110.

As shown in FIG. 1A, level 1 tree centers 112 may be initially located outside of a bounding box (e.g., outside of the clock regions).

FIG. 1B illustrates a folding operation to relocate two of the level 1 tree centers 112 to be within the bounding box while maintaining equal distances from associated level 0 tree centers 108. In layer 1, the distance between layer 0 tree centers 108 and associated layer 1 tree centers 112 is a length of two level 1 tree edges 110. To maintain the distance of two level 1 tree edge lengths, the relocated level 1 tree centers 112 may be moved towards a nearest edge of the bounding box by a distance of 2 (corresponding to the tree edge lengths at layer 1).

As shown in FIG. 1C, a level 2 tree center 116 may be placed in a center between the level 1 tree centers 112. However, the H-shaped routing tracks that connect the level 2 tree center 116 to the level 1 tree centers 112 overlap with routing tracks of layer 0. Because of the overlap, the computing device may use multiple planes to provide or receive a clock signal for the clock regions of the bounding box. There may be a number of clock tracks in a programmable global network. The global network may be broken into many segments so the clock tracks in each segment are indexed and provided programmable connection patterns to clock tracks in neighboring segments. All the same indexed clock tracks from different segments are connected to form a clock plane. Clock tracks with different indices may also connect between different segments in a limited way and the timing characteristics are different.

A clock track is a piece of metal wire manufactured in an FPGA device that is meant to carry clock or global signal in the device. In some aspects, a clock signal is configured to reach everywhere on the FPGA device. But those clock tracks are segmented, meaning every piece of them only travel a fixed distance. A manufacturer may connect the segments together, via a programming operation for the FPGA device, to allow the clock signal to reach farther distances.

The example shown in FIGS. 1A-1C may cause the final H-tree to use multiple planes based at least in part on having overlapping tree edges at different levels of the H-tree. As shown in FIG. 1D, a location of the level 2 tree edges 114 may be adjusted to reduce overlap of tree edges of lower levels of the H-tree. In some aspects, adjusting the location of the level 2 tree edges 114 may allow the computing device to avoid using multiple planes. In other words, the example shown in FIG. 1D may allow the computing device to achieve a single-plane H-tree within a bounding box.

The number and arrangement of components shown in FIGS. 1A-1D are provided as an example.

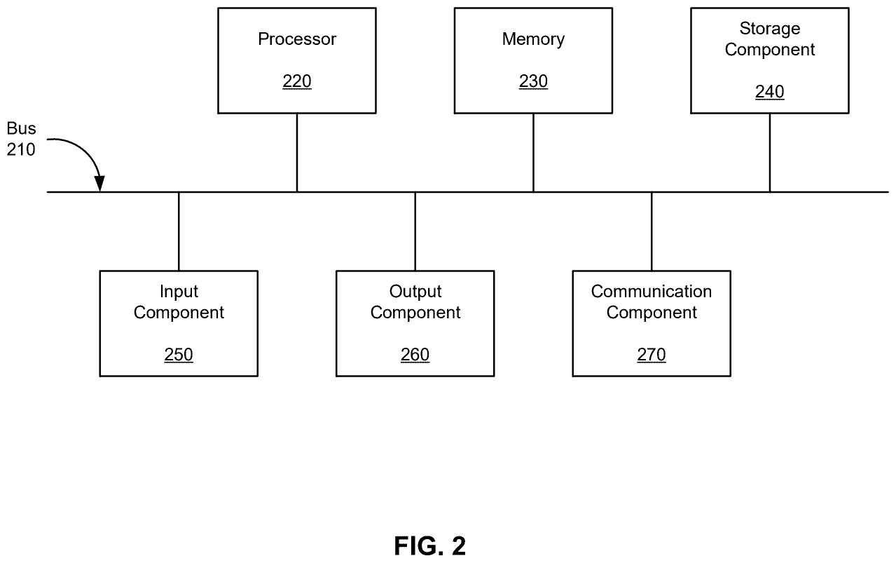

FIG. 2 is a diagram of example components of a device 200, which may correspond to one or more devices of FIG. 1, such as a controller, an FPGA, among other examples. In some implementations, the controller, the FPGA, the placer, or the global router may include one or more devices 200 and one or more components of device 200. As shown in FIG. 2, device 200 may include a bus 210, a processor 220, a memory 230, a storage component 240, an input component 250, an output component 260, and a communication component 270.

Bus 210 includes a component that enables wired or wireless communication among the components of device 200. Processor 220 includes a central processing unit, a graphics processing unit, a microprocessor, a controller, a microcontroller, a digital signal processor, a field-programmable gate array, an application-specific integrated circuit, or another type of processing component. Processor 220 is implemented in hardware, firmware, or a combination of hardware and software. In some implementations, processor 220 includes one or more processors capable of being programmed to perform a function. Memory 230 includes a random access memory, a read only memory, or another type of memory (e.g., a flash memory, a magnetic memory, or an optical memory).

Storage component 240 stores information or software related to the operation of device 200. For example, storage component 240 may include a hard disk drive, a magnetic disk drive, an optical disk drive, a solid state disk drive, a compact disc, a digital versatile disc, or another type of non-transitory computer-readable medium. Input component 250 enables device 200 to receive input, such as user input or sensed inputs. For example, input component 250 may include a touch screen, a keyboard, a keypad, a mouse, a button, a microphone, a switch, a sensor, a global positioning system component, an accelerometer, a gyroscope, or an actuator. Output component 260 enables device 200 to provide output, such as via a display, a speaker, or one or more light-emitting diodes. Communication component 270 enables device 200 to communicate with other devices, such as via a wired connection or a wireless connection. For example, communication component 270 may include a receiver, a transmitter, a transceiver, a modem, a network interface card, or an antenna.

Device 200 may perform one or more processes described herein. For example, a non-transitory computer-readable medium (e.g., memory 230 or storage component 240) may store a set of instructions (e.g., one or more instructions, code, software code, or program code) for execution by processor 220. Processor 220 may execute the set of instructions to perform one or more processes described herein. In some implementations, execution of the set of instructions, by one or more processors 220, causes the one or more processors 220 or the device 200 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 2 are provided as an example. Device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

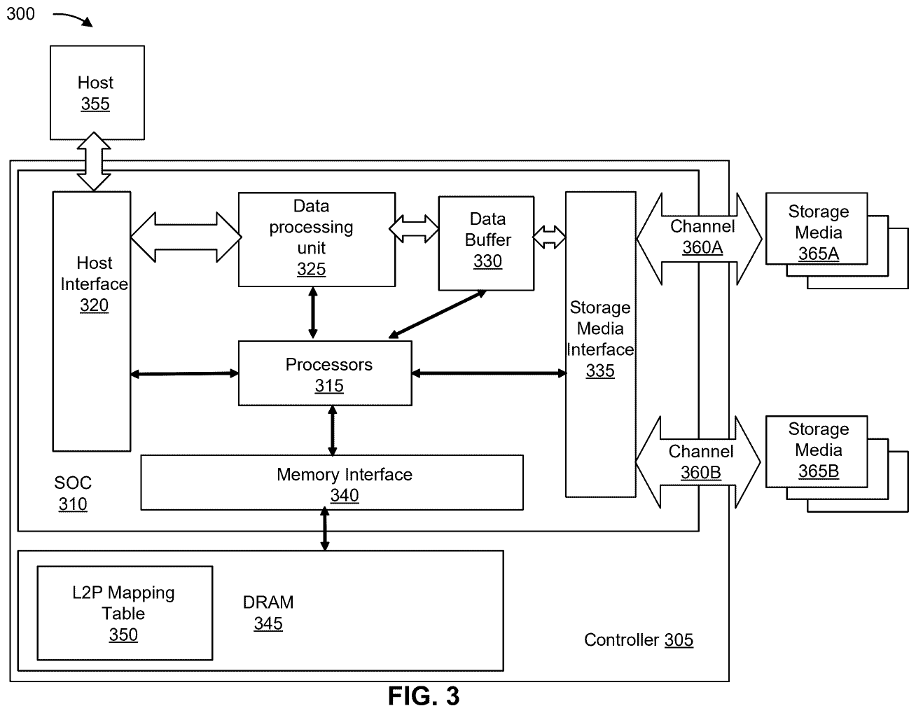

FIG. 3 is a diagram of example components of a storage device 300, which may correspond to one or more devices of FIGS. 1A-2, or 4A-4J. In some implementations, the storage device 300 may include one or more devices 200 or one or more components of device 200. In some aspects, the device 200 may include one or more storage devices 300 or one or more components of storage device 300.

As shown in FIG. 3, the storage device 300 may include a controller 305 (e.g., an SSD controller). The controller 305 may include a system on chip (SOC) 310. The SOC 310 may perform computing or processing operations for the controller 305. The SOC may include one or more processors 315 that control, command, or observe operations at one or more other components of the SOC 310. The one or more processors 315 may be communicably coupled too one or more of a host interface 320, a data processing unit 325, a data buffer 330, a media interface 335, or a memory interface 340.

The host interface 310 may be configured to communicate with a host device (e.g., host device 355 described below). The DPU 325 may manage data flow between the host interface 310 and storage media. The DPU 325 may further include a functional block that is responsible for managing data operations, such as reading, writing, error correction, or formatting. The DPU 325 may perform tasks such as page and block management (e.g., organization of data within storage media), bad block management, garbage collection, error correction and detection (e.g., using error correction codes or soft bit processing), data transformation (e.g., address mapping from host addresses to physical addresses, compression and decompression, or scrambling, among other examples), encryption and decryption, or power management associated with data operations, among other examples.

The data buffer 330 is a pipeline data buffer for the data transition. The data buffer 330 may include a temporary storage area used to transfer or process data between the storage media and a host system. The memory interface 340 is an interface between controller 310 and external DDR or DRAM, which may be used to temporarily hold the data. The memory interface 340 may provide an interface between the SOC 310 and the DRAM 345 to facilitate transfers of information. For example, the memory interface 340 may support requests to access a logical to physical (L2P) mapping table to identify a physical location of data requested by the host device, or to provide mapping information for storage in the L2P mapping table.

The controller 305 may further include DRAM 345. The DRAM 345 may locally store information that is available on demand at the controller 305 for operations of the controller 305. For example, the DRAM 345 may store an L2P mapping table 350 that maps logical locations of data and physical locations of data on connected storage media. In this way, the controller 305 may have access to mapping information for locating data on the connected storage media based at least in part on an indication associated with host data when written.

The host interface 320 may provide an interface for communicating with a host 355. For example, the host interface 320 may receive an access request or data for storage on connected storage media. In some aspects, the host interface 320 may provide data to the host after reading the data on from the connected storage media.

The storage media interface 335 may communicate via one or more channels 360 (e.g., 360A and 360B) with one or more connected storage media 365 (e.g., 365A and 365B). For example, the controller 305 may perform or initiate a read or write operation at a physical location of a storage media device 365.

In some aspects, the storage device 300 may use a combined scheme (e.g., the combined scheme 140 described in connection with FIG. 1) to write data stored in a volatile storage medium (e.g., DDR or DRAM 345 of FIG. 3) to a non-volatile storage medium (e.g., NAND or other storage medium 365). Based at least in part on the partially programed block having a first portion that is in a programmed state and a second portion that is in an unprogrammed state (e.g., having erase values), a boundary between the first portion and the second portion may be prone to voltage leaking. Using the combined scheme 140 may reduce the negative effects of voltage leaking, reduce errors, and support effective error correction of the data when read from the non-volatile storage medium. In some examples, the storage device 300 may use the combined scheme in response to a power loss event. For example, the storage device may use the combined scheme 140 to write the data from the volatile storage medium to the non-volatile storage medium after a power loss event based at least in part on the writing operation including writing a partially programmed block of the non-volatile storage medium.

The number and arrangement of components shown in FIG. 3 are provided as an example. For example, references to NAND are merely provided as examples. In practice, other non-volatile memory devices may be used in connection with storage device 300.

FIGS. 4A-4J are diagrams of examples 400A-400H of identifying H-trees associated with bounding boxes described herein. There are three scenarios for construction of an H-tree: (1) no special handling is needed for some bounding box size (2) folding is needed for some bounding box size and (3) shifting is needed for some bounding box size. Folding is defined as an operation to bring a tree center into a bounding box. The bounding box can be extended either vertically or horizontally. If the tree center is located outside either of the extended channels, then do a reflection with respect to the channel edge so that the tree center is “folded” into the channel again. If the tree center is outside both extended channels, then you perform “folding” twice so that the tree center can be back into the intersection of both extended channels, which is basically the original bounding box.

As shown in FIGS. 4A-4J, a computing device (e.g., an FPGA) may include a bounding box 402 (e.g., bounding boxes 402A-402J) having clock regions 404, a level 0 of an H-tree for distributing clock information that includes level 0 tree edges 406 connecting the clock regions 404 to level 0 tree centers 408, a layer 1 of the H-tree for distributing clock information that includes level 1 tree edges 410 connecting the clock regions 404 to level 1 tree centers 412, and a layer 2 of the H-tree for distributing clock information that includes level 2 tree edges 414 connecting the clock regions 404 to level 2 tree centers 416. Layers of the H-tree may be formed with the tree edges in a shape of a full or partial “H” shape with the tree centers of the same level in a center of the “H” shape formed by the tree edges (or where the center would be if the “H” was a full “H”).

Example 400A shown in FIG. 4A shows a 6×2 bounding box 402A having 12 clock regions 404. As shown in an initial H-tree configuration 418, the level 2 tree edges 414 and level 2 tree center 416 may be located outside of the bounding box 402A associated with the 12 clock regions 404. In some aspects, this may interfere with neighboring bounding boxes or clock regions. For example, the computing device may include multiple clock domains in a user design. Allowing H-tree centers and edges outside one clock domain's own bounding box means that the associated H-tree uses clocking tracks outside of its own bounding box. In that case, even if a software placer tried to place two clock domains without overlapping their bounding boxes, the clocking resource conflict may still arise (e.g., based at least in part on using tracks in a neighbor bounding box), causing difficulties in subsequent clock routing.

In example 400A, the level 2 tree edges 414 and level 2 tree center 416 may be folded (e.g., reflected, mirrored, or moved) back into the bounding box 402A associated with the 12 clock regions 404. In this way, the level 2 tree edges 414 and level 2 tree center 416 may avoid interfering with a neighbor bounding box or neighbor clock regions.

Example 400B shown in FIG. 4B shows a 6×3 bounding box 402B having 18 clock regions 404. As shown in an initial H-tree configuration 418B, the level 2 tree edges 414 and level 2 tree center 416 may be located outside of the bounding box 402B associated with the 18 clock regions 404. In some aspects, this may interfere with neighboring bounding boxes or clock regions. In a modified H-tree configuration 420B of example 400B, the level 2 tree edges 414 and level 2 tree center 416 may be folded (e.g., reflected, mirrored, or moved) back into the bounding box 402B associated with the 18 clock regions 404. In this way, the level 2 tree edges 414 and level 2 tree center 416 may avoid interfering with a neighbor bounding box or neighbor clock regions.

Example 400C shown in FIG. 4C shows a 6×4 bounding box 402C having 24 clock regions 404. As shown in an initial H-tree configuration 418C, the level 2 tree edges 414 and level 2 tree center 416 are located inside of the bounding box 402C associated with the 24 clock regions 404 (e.g., based at least in part on having 4 rows). In this way, the level 2 tree edges 414 and level 2 tree center 416 may avoid interfering with a neighbor bounding box or neighbor clock regions without using a modified H-tree configuration (e.g., without folding or shifting as described in context of other examples and bounding boxes).

Example 400D shown in FIG. 4D shows a 6×1 bounding box 402D having 6 clock regions 404. As shown in an initial H-tree configuration 418D, the level 1 tree edges 410, the level 1 tree centers 412, the level 2 tree edges 414, and level 2 tree center 416 may be located outside of the bounding box 402D associated with the 6 clock regions 404. In some aspects, this may interfere with neighboring bounding boxes or clock regions. In an intermediate modified H-tree configuration 420D of example 400D, the level 1 tree edges 410 and level 1 tree centers 412 may be folded (e.g., reflected, mirrored, or moved) back into the bounding box 402D associated with the 6 clock regions 404. In this way, the level 1 tree edges 410 and level 1 tree centers 412 may avoid interfering with a neighbor bounding box or neighbor clock regions. However, the level 2 tree edges 414 and the level 2 tree center 416 may still be located outside of the bounding box 402D.

In a modified H-tree configuration 422D of example 400D, the level 2 tree edges 414 and level 2 tree center 416 may be folded (e.g., reflected, mirrored, or moved) back into the bounding box 402D associated with the 6 clock regions 404. In this way, the level 2 tree edges 414 and level 2 tree center 416 may avoid interfering with a neighbor bounding box or neighbor clock regions. In example 400D, the level 2 tree edges 414 may overlap with the level 1 tree edges 410, which may cause the H-tree to use two clock planes to avoid interference.

Example 400E shown in FIG. 4E shows a 1×5 bounding box 402E having 5 clock regions 404. As shown in an initial H-tree configuration 418E, the level 1 tree edges 410, the level 1 tree centers 412, the level 2 tree edges 414, and level 2 tree center 416 may be located outside of the bounding box 402E associated with the 5 clock regions 404. In some aspects, this may interfere with neighboring bounding boxes or clock regions.

In a modified H-tree configuration 420E of example 400E, the level 1 tree edges 410 and level 1 tree centers 412 may be folded (e.g., reflected, mirrored, or moved) back into the bounding box 402E associated with the 5 clock regions 404. For example, the level 1 tree edges 410 and the level 1 tree centers 412 may be folded vertically and horizontally. In this way, the level 1 tree edges 410 and level 1 tree centers 412 may avoid interfering with a neighbor bounding box or neighbor clock regions.

Based at least in part on the level 1 tree centers 412 being in a single column, the level 2 tree edges 414 may connect the level 1 tree centers 412 without folding. In the case of FIG. 4E, the routing segment between the two level 1 tree centers are not occupied at all. Hence it immediately yields a straightforward solution that does not benefit from folding in contrast to FIG. 4D, where the routing segment between the two level 1 tree centers have already been occupied by level 1 tree edges. Because the initial H-tree configuration 418D of example 400D includes a routing segment between two level 1 tree center does not trigger a straightforward solution without folding. In the case of example 400D, the H-tree is configured with a level 2 tree center outside the bounding box, and then the level 2 tree center is folded back inside the bounding box.

A level 2 tree center 416 may be positioned between the level 1 tree centers 412. For example, a subsequent layer of tree edges (e.g., the level 2) are constructed based on prior layer's tree centers after any special handling, such as folding. In this way, the subsequent layer of tree edges starts with the prior layer's tree centers that are already located within the bounding box. The subsequent layer tree edges are constructed in the usual way, and special handling like folding is only needed if the usual way of constructing this subsequent layer tree leads to tree center being outside the bounding box.

In FIG. 4E, there are only two level 1 tree centers as shown as the white squares. The level 2 H-tree may be constructed without folding by placing the level 2 tree center 416 at a middle point of the two level 1 tree center 412, and connect with level 2 tree edges 414. That leads to the level 2 tree center 416 being placed within the bounding box 402C without special handling such as folding. In contrast, example 400D of Fig, D shows in the modified H-tree configuration 422D that folding may be used to construct the level 2 tree to avoid a level 2 tree center being located outside the bounding box, as shown in the modified H-tree configuration 420D before folding.

Example 400F shown in FIG. 4F shows a 2×5 bounding box 402F having 10 clock regions 404. As shown in an initial H-tree configuration 418F, the level 1 tree edges 410, one of the level 1 tree centers 412, the level 2 tree edges 414, and level 2 tree center 416 may be located outside of the bounding box 402F associated with the 10 clock regions 404. In some aspects, this may interfere with neighboring bounding boxes or clock regions.

In a modified H-tree configuration 420F of example 400F, the level 1 tree edges 410 and one of the level 1 tree centers 412 may be folded (e.g., reflected, mirrored, or moved) back into the bounding box 402F associated with the 10 clock regions 404. For example, the level 1 tree edges 410 and the level 1 tree centers 412 may be folded vertically. In this way, the level 1 tree edges 410 and level 1 tree centers 412 may avoid interfering with a neighbor bounding box or neighbor clock regions. Based at least in part on the level 1 tree centers 412 being in a single column, the level 2 tree edges 414 may connect the level 1 tree centers 412 without folding. A level 2 tree center 416 may be positioned between the level 1 tree centers 412.

Example 400G shown in FIG. 4G shows a 3×5 bounding box 402G having 15 clock regions 404. As shown in an initial H-tree configuration 418G, the level 1 tree edges 410, one of the level 1 tree centers 412, the level 2 tree edges 414, and level 2 tree center 416 may be located outside of the bounding box 402G associated with the 15 clock regions 404. In some aspects, this may interfere with neighboring bounding boxes or clock regions.

In a modified H-tree configuration 420G of example 400G, the level 1 tree edges 410 and one of the level 1 tree centers 412 may be folded (e.g., reflected, mirrored, or moved) back into the bounding box 402G associated with the 10 clock regions 404. For example, one of the level 1 tree edges 410 and one of the level 1 tree centers 412 may be folded vertically. In this way, the level 1 tree edges 410 and level 1 tree centers 412 may avoid interfering with a neighbor bounding box or neighbor clock regions. The level 2 tree edges 416 and the level 2 tree center 418 may be positioned within the bounding box 402G such that the level 2 tree center is at a vertical position that is halfway between the level 1 tree centers.

Example 400H shown in FIG. 4H shows a 1×6 bounding box 402H having 6 clock regions 404. As shown in an initial H-tree configuration 418H, the level 1 tree edges 410, the level 1 tree centers 412, the level 2 tree edges 414, and level 2 tree center 416 may be located outside of the bounding box 402H associated with the 6 clock regions 404. In some aspects, this may interfere with neighboring bounding boxes or clock regions.

In a modified H-tree configuration 420H of example 400H, the level 1 tree edges 410 and level 1 tree centers 412 may be folded (e.g., reflected, mirrored, or moved) back into the bounding box 402H associated with the 5 clock regions 404. For example, the level 1 tree edges 410 and the level 1 tree centers 412 may be folded horizontally. In this way, the level 1 tree edges 410 and level 1 tree centers 412 may avoid interfering with a neighbor bounding box or neighbor clock regions. Based at least in part on the level 1 tree centers 412 being in a single column, the level 2 tree edges 414 may connect the level 1 tree centers 412 without folding. A level 2 tree center 416 may be positioned between the level 1 tree centers 412.

Example 400I shown in FIG. 4I shows a 2×6 bounding box 402I having 12 clock regions 404. As shown in an initial H-tree configuration 418I, the level 1 tree edges 410, one of the level 1 tree centers 412, the level 2 tree edges 414, and level 2 tree center 416 are located inside of the bounding box 402I associated with the 12 clock regions 404. Additionally, the level 1 tree centers 412 are located in a single column. In this way, the level 2 tree edges 414 and level 2 tree center 416 may avoid interfering with a neighbor bounding box or neighbor clock regions without using a modified H-tree configuration.

Example 400J shown in FIG. 4J shows a repeating H-tree structure with an initial 5×5 bounding box 418J having 25 clock regions 404. In example 400J, a computing device may shift the initial bounding box 418J to a shifted bounding box 420J to include level 1 tree edges 410, level 1 tree centers 412, level 2 tree edges 414, and level 2 tree centers 416. In this way, the shifted bounding box 420J support avoidance of interference of tree edges and tree centers with a neighbor bounding box or neighbor clock regions without using a modified H-tree configuration.

In some aspects, the computing device may use shifting of bounding boxes for a repeating H-tree structure to align a partial sub H-tree at the bounding box boundary. For example, shifting may be used for bounding boxes having a height of 5 and a width that is greater than, or equal to, 5. In some aspects, the computing device may use shifting, when operations described in connection with FIGS. 4A-4I are insufficient, to provide a solution to interference of tree edges and tree centers with a neighbor bounding box or neighbor clock regions.

The number and arrangement of components shown in FIGS. 4A-4J are provided as an example.

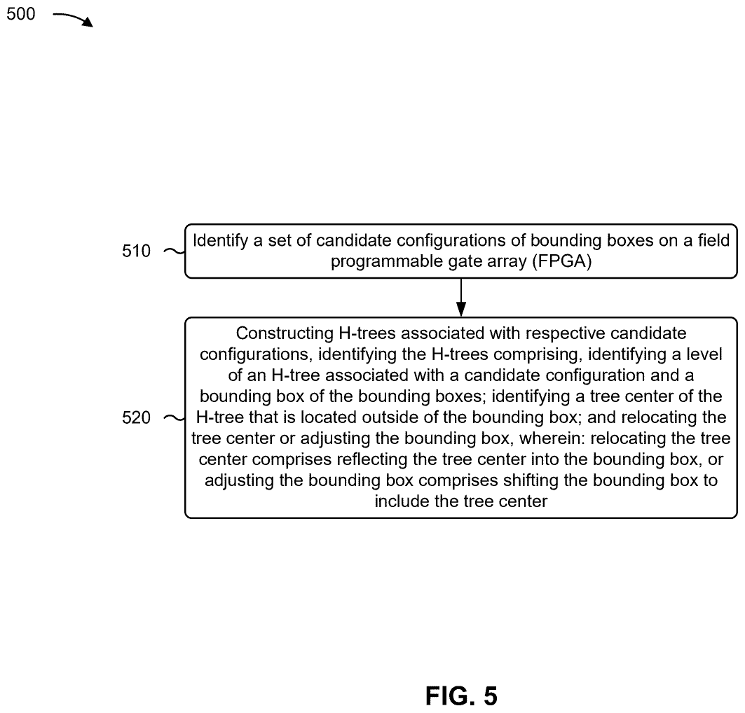

FIG. 5 is a flowchart of an example process 500 associated with configuring an H-tree associated with a bounding box. In some implementations, one or more process blocks of FIG. 5 may be performed by a computing device (e.g., device 200). In some implementations, one or more process blocks of FIG. 5 may be performed by another device or a group of devices separate from or including the computing device, such as a placer or a global router. Additionally, or alternatively, one or more process blocks of FIG. 5 may be performed by one or more components of device 200, such as processor 220, memory 230, storage component 240, input component 250, output component 260, or communication component 270. Additionally, or alternatively, one or more process blocks of FIG. 5 may be performed by one or more components of storage device 300, such as SOC 310, processors 315, media interface 335, or DRAM 345, among other examples.

As shown in FIG. 5, process 500 may include identifying a set of candidate configurations of bounding boxes on a field programmable gate array (FPGA) (block 510). For example, the computing device may identify a set of candidate configurations of bounding boxes on a field programmable gate array (FPGA). For example, a vendor may have a physical design tool to configure a physical placement of clock domains in a user design for an FPGA. The physical design tool may work through iterations of candidate configurations and explore different placement solutions that contain different clock domain placement bounding boxes. These candidate configurations of possible placement bounding boxes may be used by the physical design tool to eventually configure the FPGA device to physically realize the clock routing tree topology.

As further shown in FIG. 5, process 500 may include constructing H-trees associated with respective candidate configurations, identifying the H-trees comprising: identifying a level of an H-tree associated with a candidate configuration and a bounding box of the bounding boxes; identifying a tree center of the H-tree that is located outside of the bounding box; and relocating the tree center or adjusting the bounding box, wherein: relocating the tree center comprises reflecting the tree center into the bounding box, or adjusting the bounding box comprises shifting the bounding box to include the tree center (block 520). For example, the computing device may construct H-trees associated with respective candidate configurations, identifying the H-trees comprising: identifying a level of an H-tree associated with a candidate configuration and a bounding box of the bounding boxes; identifying a tree center of the H-tree that is located outside of the bounding box; and relocating the tree center or adjusting the bounding box, wherein: relocating the tree center comprises reflecting the tree center into the bounding box, or adjusting the bounding box comprises shifting the bounding box to include the tree center, as described above.

Process 500 may include additional implementations, such as any single implementation or any combination of implementations described below and/or in connection with one or more other processes described elsewhere herein.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

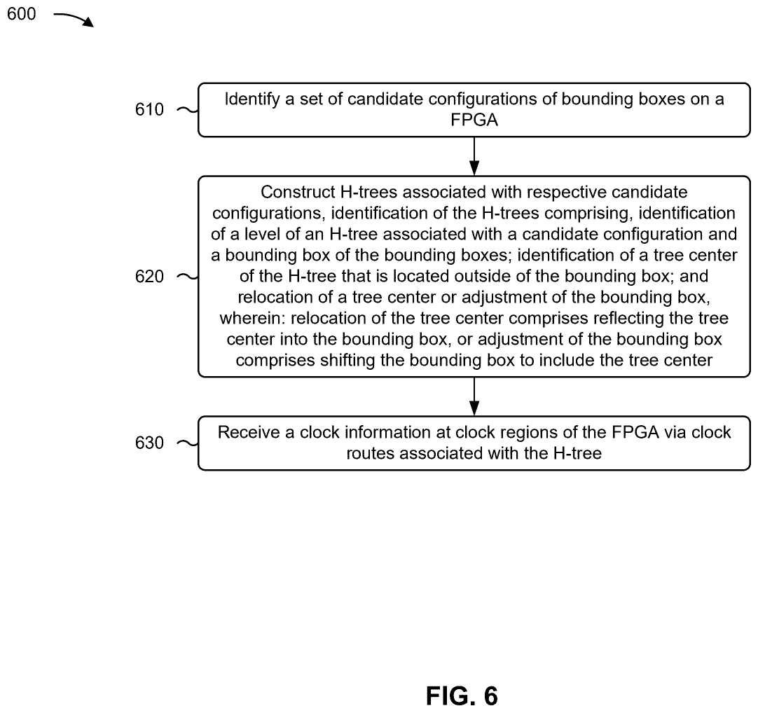

FIG. 6 is a flowchart of an example process 600 associated with configuring an H-tree associated with a bounding box. In some implementations, one or more process blocks of FIG. 6 may be performed by a computing device (e.g., device 200). In some implementations, one or more process blocks of FIG. 6 may be performed by another device or a group of devices separate from or including the computing device, such as a placer or a global router. Additionally, or alternatively, one or more process blocks of FIG. 6 may be performed by one or more components of device 200, such as processor 220, memory 230, storage component 240, input component 250, output component 260, or communication component 270. Additionally, or alternatively, one or more process blocks of FIG. 6 may be performed by one or more components of storage device 300, such as SOC 310, processors 315, media interface 335, or DRAM 345, among other examples.

As shown in FIG. 6, process 600 may include identifying a set of candidate configurations of bounding boxes on a FPGA (block 610). For example, the computing device may identify a set of candidate configurations of bounding boxes on a FPGA, as described above.

As further shown in FIG. 6, process 600 may include constructing H-trees associated with respective candidate configurations, identification of the H-trees comprising: identification of a level of an H-tree associated with a candidate configuration and a bounding box of the bounding boxes; identification of a tree center of the H-tree that is located outside of the bounding box; relocation of a tree center or adjustment of the bounding box, wherein: relocation of the tree center comprises reflecting the tree center into the bounding box, or adjustment of the bounding box comprises shifting the bounding box to include the tree center (block 620). For example, the computing device may construct H-trees associated with respective candidate configurations, identification of the H-trees comprising: identification of a level of an H-tree associated with a candidate configuration and a bounding box of the bounding boxes; identification of a tree center of the H-tree that is located outside of the bounding box; relocation of a tree center or adjustment of the bounding box, wherein: relocation of the tree center comprises reflecting the tree center into the bounding box, or adjustment of the bounding box comprises shifting the bounding box to include the tree center, as described above.

As further shown in FIG. 6, process 600 may include receiving a clock information at clock regions of the FPGA via clock routes associated with the H-tree (block 630). For example, the computing device may receive a clock information at clock regions of the FPGA via clock routes associated with the H-tree, as described above.

Process 600 may include additional implementations, such as any single implementation or any combination of implementations described below and/or in connection with one or more other processes described elsewhere herein.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a flowchart of an example process 700 associated with configuring an H-tree associated with a bounding box. In some implementations, one or more process blocks of FIG. 7 may be performed by a computing device (e.g., device 200). In some implementations, one or more process blocks of FIG. 7 may be performed by another device or a group of devices separate from or including the computing device, such as a placer or a global router. Additionally, or alternatively, one or more process blocks of FIG. 7 may be performed by one or more components of device 200, such as processor 220, memory 230, storage component 240, input component 250, output component 260, or communication component 270. Additionally, or alternatively, one or more process blocks of FIG. 7 may be performed by one or more components of storage device 300, such as SOC 310, processors 315, media interface 335, or DRAM 345, among other examples.

As shown in FIG. 7, process 700 may include identifying a set of candidate configurations of bounding boxes on a field programmable gate array (FPGA) (block 710). For example, the computing device may identify a set of candidate configurations of bounding boxes on a field programmable gate array (FPGA), as described above.

As further shown in FIG. 7, process 700 may include identifying an H-tree associated with a bounding box of the bounding boxes of the FPGA, identification of the H-trees comprising: identification of a level of the H-tree of the bounding box; identification of a tree center of the H-tree that is located outside of the bounding box; and relocation of the tree center based at least in part on reflecting the tree center into the bounding box (block 720). For example, the computing device may identify an H-tree associated with a bounding box of the bounding boxes of the FPGA, identification of the H-trees comprising: identification of a level of the H-tree of the bounding box; identification of a tree center of the H-tree that is located outside of the bounding box; and relocation of the tree center based at least in part on reflecting the tree center into the bounding box, as described above.

Process 700 may include additional implementations, such as any single implementation or any combination of implementations described below and/or in connection with one or more other processes described elsewhere herein.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

In a first implementation of any of processes 500, 600, or 700, adjusting the bounding box comprises maintaining a size of the bounding box.

In a second implementation of any of processes 500, 600, or 700, alone or in combination with the first implementation, the bounding box is associated with a set of clock regions of the FPGA.

In a third implementation of any of processes 500, 600, or 700, alone or in combination with one or more of the first and second implementations, endpoints of the level of the H-tree are associated with tree centers of a lower level of the H-tree.

In a fourth implementation of any of processes 500, 600, or 700, alone or in combination with one or more of the first through the third implementations, any of processes 500, 600, or 700 include receiving a clock signal at clock regions of the FPGA via clock routes associated with the H-tree.

In a fifth implementation of any of processes 500, 600, or 700, alone or in combination with one or more of the first through fourth implementations, any of processes 500, 600, or 700 includes receiving the clock signal for a first level of the FPGA on a first plane of the H-tree, and receiving the clock signal for a second level of the FPGA on a second plane of the H-tree based at least in part on relocating the tree center being associated with an overlap of clock routes from different layers of the H-tree.

In a sixth implementation of any of processes 500, 600, or 700, alone or in combination with one or more of the first through fifth implementations, relocating the tree center comprises reflecting the tree center along a dimension by a number of tree edge lengths of a lowest level of the H-tree.

In a seventh implementation of any of processes 500, 600, or 700, alone or in combination with one or more of the first through sixth implementations, relocating the tree center or adjusting the bounding box comprises adjusting the bounding box based at least in part on relocating the tree center being associated with an overlap of clock routes from different layers of the H-tree.

In an eighth implementation of any of processes 500, 600, or 700, alone or in combination with one or more of the first through seventh implementations, the computing device performs operations of a global router.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems or methods described herein may be implemented in different forms of hardware, firmware, or a combination of hardware and software. The actual specialized control hardware or software code used to implement these systems or methods is not limiting of the implementations. Thus, the operation and behavior of the systems or methods are described herein without reference to specific software code—it being understood that software and hardware can be used to implement the systems or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method performed by a computing device, the method comprising:
identifying a set of candidate configurations of bounding boxes on a field programmable gate array (FPGA); and
constructing H-trees associated with respective candidate configurations, identifying the H-trees comprising:
identifying a level of an H-tree associated with a candidate configuration and a bounding box of the bounding boxes;
identifying a tree center of the H-tree that is located outside of the bounding box; and
relocating the tree center or adjusting the bounding box, wherein:
relocating the tree center comprises reflecting the tree center into the bounding box, or
adjusting the bounding box comprises shifting the bounding box to include the tree center.

2. The method of claim 1, wherein adjusting the bounding box comprises maintaining a size of the bounding box.

3. The method of claim 1, wherein the bounding box is associated with a set of clock regions of the FPGA.

4. The method of claim 1, wherein endpoints of the level of the H-tree are associated with tree centers of a lower level of the H-tree.

5. The method of claim 1, comprising receiving a clock signal at clock regions of the FPGA via clock routes associated with the H-tree.

6. The method of claim 1, wherein relocating the tree center comprises:
reflecting the tree center along a dimension by a number of tree edge lengths of a lowest level of the H-tree.

7. The method of claim 6, wherein the number is 2.

8. The method of claim 1, wherein relocating the tree center or adjusting the bounding box comprises adjusting the bounding box based on relocating the tree center being associated with an overlap of clock routes from different layers of the H-tree.

9. The method of claim 1, wherein the computing device performs operations of a global router.

10. A system comprising:
a computing device, associated with a field programmable gate array (FPGA), to:
identify a set of candidate configurations of bounding boxes on an FPGA;
construct H-trees associated with respective candidate configurations, identification of the H-trees comprising:
identification of a level of an H-tree associated with a candidate configuration and a bounding box of the bounding boxes;
identification of a tree center of the H-tree that is located outside of the bounding box; and
relocation of the tree center or adjustment of the bounding box, wherein:
relocation of the tree center comprises reflecting the tree center into the bounding box, or
adjustment of the bounding box comprises shifting the bounding box to include the tree center; and
receive a clock information at clock regions of the FPGA via clock routes associated with the H-tree.

11. The system of claim 10, wherein adjustment of the bounding box comprises maintaining a size of the bounding box.

12. The system of claim 10, wherein endpoints of the level of the H-tree are associated with tree centers of a lower level of the H-tree.

13. The system of claim 10, wherein relocation of the tree center comprises:
reflection of the tree center along a dimension by a number of tree edge lengths of a lowest level of the H-tree.

14. The system of claim 10, wherein the computing device is further to:
receive a first clock signal for a first subset of clock regions of the FPGA on a first plane; and
receive a second clock signal for a second subset of clock regions of the FPGA on a second plane based on relocating the tree center being associated with an overlap of clock routes from different layers of the H-tree.

15. The system of claim 10, wherein relocation of the tree center or adjustment of the bounding box comprises adjustment of the bounding box based on relocation of the tree center being associated with an overlap of clock routes from different layers of the H-tree.

16. The system of claim 11, wherein the computing device performs operations a global router.

17. A computer program product comprising:
one or more computer readable storage media, and program instructions collectively stored on the one or more computer readable storage media, the program instructions comprising:
program instructions to identify a set of candidate configurations of bounding boxes on a field programmable gate array (FPGA); and
program instructions to construct H-trees associated with respective candidate configurations, identification of the H-trees comprising:
identification of a level of an H-tree associated with a candidate configuration and a bounding box of the bounding boxes;
identification of a tree center of the H-tree that is located outside of the bounding box; and
relocation of a tree center based at least in part on reflecting the tree center into the bounding box.

18. The computer program product of claim 17, wherein adjustment of the bounding box comprises maintaining a size of the bounding box.

19. The computer program product of claim 17, wherein the bounding box is associated with a set of clock regions of the FPGA.

20. The computer program product of claim 17, wherein endpoints of the level of the H-tree are associated with tree centers of a lower level of the H-tree.

21. The computer program product of claim 17, wherein the program instructions comprise program instructions to receive a clock signal at clock regions of the FPGA via clock routes associated with the H-tree.

22. The computer program product of claim 17, wherein relocation of the tree center comprises:
reflection of the tree center along a dimension by a number of tree edge lengths of a lowest level of the H-tree.

23. The computer program product of claim 22, wherein the number is 2.

24. The computer program product of claim 17, wherein relocation of the tree center or adjustment of the bounding box comprises adjustment of the bounding box based on relocation of the tree center being associated with an overlap of clock routes from different layers of the H-tree.
